(19) United States
(12) Patent Application Publication
(10) Pub. No.: US 2023/0145234 A1
(43) Pub. Date: May 11, 2023

(54) ANTENNA APPARATUS AND TERMINAL DEVICE

(71) Applicant: HUIZHOU TCL MOBILE COMMUNICATION CO., LTD, Huizhou, Guangdong (CN)

(72) Inventors: Hongjuan Xing, Huizhou, Guangdong (CN); Ke Ren, Huizhou, Guangdong (CN); Hai Cai, Huizhou, Guangdong (CN); Xinrong An, Huizhou, Guangdong (CN)

(73) Assignee: HUIZHOU TCL MOBILE COMMUNICATION CO., LTD, Huizhou, Guangdong (CN)

(21) Appl. No.: 17/758,970

(22) PCT Filed: Feb. 26, 2020
(86) PCT No.: PCT/CN2020/076749

§ 371 Date: Jan. 15, 2023

(30) Foreign Application Priority Data
Jan. 17, 2020 (CN) 202010053567.0

(51) Int. Cl. H01Q 23/00; H01Q 1/24; H01Q 1/38; H01Q 1/48; H01Q 3/36

(52) U.S. Cl. CPC H01Q 23/00; H01Q 1/243; H01Q 1/38; H01Q 1/48; H01Q 3/36

(57) ABSTRACT

Disclosed in the present application are an antenna apparatus and a terminal device. The present application, by means of adding a power attenuator to each antenna unit of an array antenna, and the power attenuators being used to load a Dolph-Chebyshev algorithm and/or a Taylor algorithm so as to attenuate power of an input signal, can effectively inhibit side lobe gain of the array antenna and ensure identical main lobe gain and width.

This disclosure claims priority benefit to Chinese Patent Application No. 202010053567.0, filed on Jan. 17, 2020, and entitled “ANTENNA APPARATUS AND TERMINAL DEVICE”, the entire contents of which are hereby incorporated by reference in its entirety in this disclosure.

### FIELD OF THE DISCLOSURE

The present application relates to a field of mobile communication technology, and more specifically, to an antenna apparatus and a terminal device.

### BACKGROUND

Due to high frequency of millimeter waves and large attenuation of signal transmission, 5G mobile terminal devices mostly use array antenna beamforming to improve signal strength and use beam scanning technology to expand an angle of a signal in communication. A principle of beamforming and beam scanning is to control phase and signal amplitude of each transmitting and receiving unit in a millimeter wave array antenna module, thereby enhancing intensity and angles radiated by an array antenna.

However, for some 5G millimeter-wave mobile communication terminal products on the market at present, an antenna array only uses a digital phase shifter to control the phase of the transmitting and receiving units in the array antenna, without controlling an amplitude of a signal input to a single unit. Therefore, when the array antenna works at certain angles, especially edge angles, exceedingly large sidelobes occur, thus affecting signal reception and transmission efficiency and causing a risk of introducing other external interference signals.

### SUMMARY OF DISCLOSURE

### Technical Problem

The embodiments of the present application provide an antenna apparatus and a terminal device, which can effectively solve a problem that a sidelobe amplitude of a conventional antenna array is too large, affecting signal reception and transmission efficiency and introducing other external interference signals.

### SOLUTIONS TO PROBLEM

### Technical Solutions

According to an aspect of the present application, an embodiment of the present application provides an antenna apparatus, including: a power splitter; a plurality of antenna units electrically connected to the power splitter, and each antenna unit includes: a power attenuator electrically connected to the power splitter, wherein the power attenuator is configured to load an algorithm to attenuate power of an input signal; and a radiation portion configured to transmit a received signal to the power attenuator and/or to receive a transmitted signal from the power attenuator; each antenna unit further includes: a phase shifter electrically connected to the power attenuator; and the algorithm is one of a Dolph-Chebyshev algorithm, a Taylor algorithm, and combinations thereof.

Further, the radiation portion is disposed on a first dielectric substrate.

Further, the power attenuator is disposed on a second dielectric substrate.

According to another aspect of the present application, an embodiment of the present application provides an antenna apparatus, including: a power splitter; and a plurality of antenna units electrically connected to the power splitter, and each antenna unit includes: a power attenuator electrically connected with the power splitter, wherein the power attenuator is configured to load an algorithm to attenuate power of an input signal; and a radiation portion configured to transmit a received signal to the power attenuator and/or to receive a transmitted signal from the power attenuator.

Further, each antenna unit further includes: a phase shifter, electrically connected to the power attenuator.

Further, the radiation portion is disposed on a first dielectric substrate.

Further, the power attenuator is disposed on a second dielectric substrate.

Further, the phase shifter is disposed on the second dielectric substrate.

Further, a ground plate is further disposed between the first dielectric substrate and the second dielectric substrate, and a plurality of through-holes are defined on the ground plate, and a number of the through-holes is same as a number of the antenna units.

Further, the plurality of antenna units include: a first antenna unit, a second antenna unit, a third antenna unit, and a fourth antenna unit; and the first antenna unit, the second antenna unit, the third antenna unit, and the fourth antenna unit are arranged in a straight line.

Further, the algorithm is one of a Dolph-Chebyshev algorithm, a Taylor algorithm, and combinations thereof.

Further, amplitudes of the signals input by each antenna unit are same.

According to another aspect of the present application, an embodiment of the present application provides a terminal device, including the above-mentioned antenna apparatus.

### Advantages of the Present Application

The advantage of the present application is that, the present application, by means of adding a power attenuator to each antenna unit of an array antenna, and the power attenuator being used to load a Dolph-Chebyshev algorithm and/or a Taylor algorithm so as to attenuate power of an input signal, can effectively inhibit side lobe of array antenna, and ensure identical man lobe gain and width.

### BRIEF DESCRIPTION OF THE DRAWINGS

To describe the technical solutions of the embodiments of this disclosure more clearly, the following briefly introduces the accompanying drawings required for describing the embodiments. Apparently, the accompanying drawings in the following description show only some embodiments of this disclosure, and a person of ordinary skill in the art may still derive other drawings from these accompanying drawings without creative efforts.

FIG. 1 is a schematic structural diagram of a circuit principle of an antenna apparatus provided in a first embodiment of the present application.

FIG. 2 is a schematic structural diagram of the antenna apparatus provided by an embodiment of the present application.

FIG. 3 is a schematic structural diagram of a circuit principle of an antenna apparatus provided in a second embodiment of the present application.

FIG. 4 is a schematic structural diagram of a terminal device provided by an embodiment of the present application.

### DETAILED DESCRIPTION

The following clearly and completely describes the technical solutions in the embodiments of this disclosure with reference to the accompanying drawings in the embodiments of this disclosure. Apparently, the described embodiments are some of the embodiments of this disclosure rather than all of the embodiments. All other embodiments obtained by a person skilled in the art based on the embodiments of this disclosure without creative efforts shall fall within the protection scope of this disclosure.

In the description of the present application, it is to be understood that terms such as “center”, “longitudinal”, “lateral”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential” should be construed to refer to the orientation as then described or as shown in the drawings under discussion. These relative terms are for convenience of description only and do not require that the present application be constructed or operated in a particular orientation. Accordingly, this disclosure should not therefore be construed as a limitation on the present application. In addition, terms such as “first” and “second” are used herein for purposes of description and are intended to indicate or imply relative importance or significance or to imply the number of indicated technical features. Thus, the feature defined with “first”, “second” may explicitly or implicitly include at least one of the features. Furthermore, in the description of the present application, “multiple” means at least two, such as two, three, etc., unless clearly specified otherwise.

In the present application, unless clearly specified or limited otherwise, terms “mounted”, “connected”, “coupled”, “fixed” and the like are used in a broad sense, and may include, for example, fixed connections, detachable connections, or integral connections; may also be mechanical or electrical connections or can communicate with each other; may also be direct connections or indirect connections via intervening structures; may also be inner communications of two elements or an interactive relationship between two elements, as can be understood by those skilled in the art depending on specific contexts.

In the present application, unless clearly specified or limited otherwise, a structure in which a first feature is “on” or “below” a second feature may include an embodiment in which the first feature in direct contact with the second feature, and may also include an embodiment in which the first feature and the second feature are not in direct contact with each other, but are contacted via an additional feature formed therebetween. Furthermore, a first feature “on”, “above” and “on top of” a second feature may include an embodiment in which the first feature is right or obliquely “on”, “above” or “on top of” the second feature, or simply means that the first feature is at a height higher than that of the second feature. While a first feature “below”, “under” or “on bottom of” a second feature may include an embodiment in which the first feature is right or obliquely “below”, “under” or “on bottom of” the second feature, or simply means that the first feature is at a height lower than that of the second feature.

The following disclosure provides a number of different implementations or examples for implementing the different structures of the present application. To simplify the disclosure of the present application, the components and settings of the specific examples are described below. Certainly, they are merely examples, and are not intended to limit the present disclosure. In addition, the present application may repeat reference numerals and/or reference letters in different examples. Such repetition is for the purpose of simplicity and clarity, and does not indicate the relationship between the various embodiments and/or the settings. In addition, the present application provides examples of various specific processes and materials, but those of ordinary skill in the art will be aware of the application of other processes and/or the use of other materials.

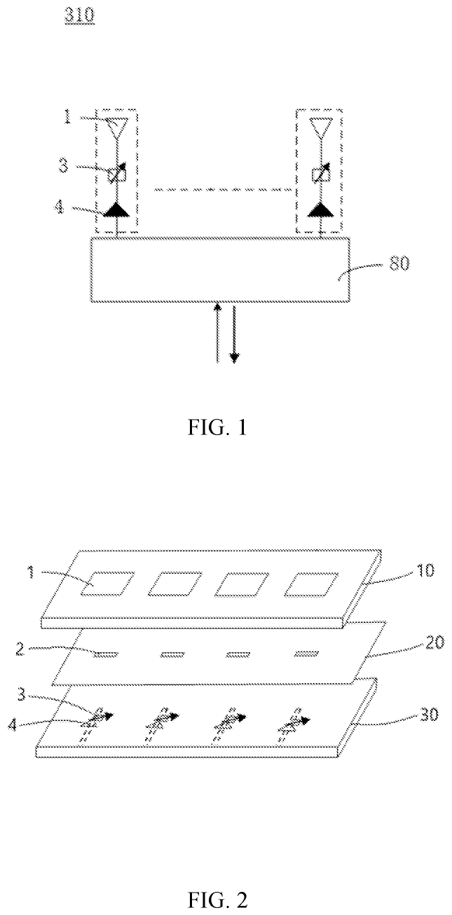

As shown in FIG. 1, which is a schematic diagram of a circuit principle of an antenna apparatus provided in a first embodiment of the present application, the antenna apparatus includes: a power splitter 80 and a plurality of antenna units. The antenna apparatus is used in a terminal device. The power splitter 80 described in the first embodiment of the present application is also called a power divider, which is a device to split one-way input signal energy into two or multiple ways of output energy being same or different. Certainly, the device may combine multiple ways of signal energies into a one-way output energy reversely, and the device is called a combiner in this case.

Each of the antenna units is electrically connected to the power splitter 80, and each of the antenna units includes: a power attenuator 4 and a radiation portion 1.

Referring to FIG. 2 in combination, the radiation portion 1 is disposed on a first dielectric substrate 10 and the power attenuator 4 is disposed on a second dielectric substrate 30. A ground plate 20 is further disposed between the first dielectric substrate 10 and the second dielectric substrate 30. A plurality of through-holes 2 are defined on the ground plate 20, and a number of the through-holes 2 is same as a number of the antenna units.

The power attenuator 4 is electrically connected to the power splitter 80, and the power attenuator 4 is configured to load an algorithm to attenuate power of an input signal. The algorithm is one of a Dolph-Chebyshev algorithm, a Taylor algorithm, and combinations thereof. When there are more than four antenna units in the antenna apparatus, generally at most four antenna units are divided into a first group of antenna arrays, and extra antenna units may be divided into a second group of antenna arrays, or even more groups of antenna arrays. All of the power attenuators 4 in a same group of antenna arrays may be uniformly loaded with the Dolph-Chebyshev algorithm, or may be uniformly loaded with the Taylor algorithm, or some of the power attenuators 4 may be loaded with the Dolph-Chebyshev algorithm and remaining of the power attenuators 4 may be loaded with the Taylor algorithm. That is to say, the Dolf-Chebyshev algorithm and the Taylor algorithm may be mixed in the antenna apparatus, or only one of the algorithms may be loaded in the antenna apparatus.

It should be noted that current distribution in the Dolph-Chebyshev algorithm may transfer a part of energy of sidelobes to a main lobe, thereby reducing sidelobe levels and obtaining a narrowest main lobe width, or obtaining a lowest sidelobe level at a given main lobe width. Unlike the Dolf-Chebyshev algorithm that maintains a same sidelobe level, Taylor distribution may allow several sidelobes near the main lobe to have same levels, while remaining sidelobe levels tend to decrease sequentially. The Taylor distribution adjusts the sidelobe levels by positions of nulls of a lobe, and the sidelobe levels farther away from the main lobe are known to decrease sequentially. For the sidelobes close to the main lobe, the positions of the nulls of the lobe are shifted towards a direction of the main lobe so as to reduce corresponding sidelobe levels.

The plurality of antenna units may be arranged in a straight line, but is not limited thereto, in other embodiments, the plurality of antenna units may be arranged in a curve.

Amplitudes of signals input by each of the antenna units are same, but amplitudes of the signals output by each of the antenna units are not necessarily same. Specifically, the amplitudes of the signals output by each of the antenna units are determined according to positions of each of the antenna units arranged in the antenna array. For example, when the antenna array is arranged in a straight line, output amplitudes of the antenna units in a middle are greater than output amplitudes of the antenna units on two sides.

The radiation portion 1 is configured to transmit a received signal to the power attenuator 4 or receive a transmitted signal from the power attenuator 4.

The antenna apparatus further includes: a phase shifter 3.

The phase shifter 3 is electrically connected to the power attenuator 4, and the phase shifter 3 is configured to change phases of the main lobe of the signal.

When the antenna apparatus transmits a signal, the signal is transmitted from a corresponding circuit inside the terminal device to the power splitter 80, and the power splitter 80 divides the signal into multiple-ways (a same number as the plurality of antenna units) of equal-amplitude signals. Each of the multiple-ways of equal-amplitude signals passes through the power attenuator 4, respectively, and the power attenuator 4 is loaded with the Dolph-Chebyshev algorithm or the Taylor algorithm to attenuate power of the equal-amplitude signals inputted accordingly. An attenuated signal passes through the phase shifter 3, which adjusts transmission phase thereof. Finally, it is emitted from the radiation portion 1 of the antenna unit. The radiation portion 1 and the phase shifter 3 are not directly connected, and the signal is coupled to the radiation portion 1 through the through-hole 2 on the ground plate 20.

When the antenna apparatus receives a signal from outside the terminal device, the signal is fed by a plurality of radiation portions 1 into the plurality of antenna units. Each of the plurality of radiation portions 1 couples the received signal through the through-hole 2 to the phase shifter 3, by which a received phase of the signal is adjusted. A phase-adjusted signal is passed through the power attenuator 4, and the power attenuator 4 is loaded with the Dolph-Chebyshev algorithm or the Taylor algorithm to attenuate power of the received signal accordingly. After attenuated multi-way signals are sent to the power splitter 80, the power splitter 80 will combine the attenuated multi-way signals into one signal at this time.

An advantage of the present application is that, in the present application, a power attenuator is added to each antenna unit of the array antenna, and the power attenuators is used to load the Dolph-Chebyshev algorithm and/or the Taylor algorithm so as to attenuate power of the input signal, which can effectively inhibit side lobe gain of the array antenna and ensure identical main lobe gain and width.

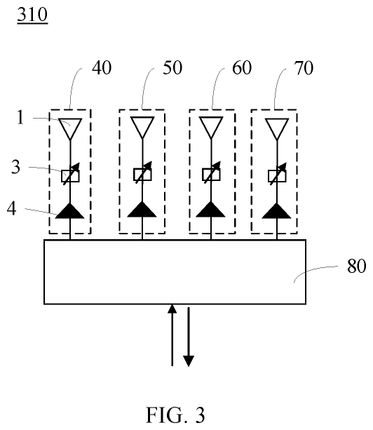

As shown in FIG. 3, which is a schematic diagram of a circuit principle of an antenna apparatus provided in a second embodiment of the present application, the antenna apparatus 310 includes: a power splitter 80 and a plurality of antenna units. The antenna apparatus 310 is used in a terminal device. The power splitter 80 described in the second embodiment of the present application is also called a power divider, which is a device to split one-way input signal energy into two or multiple ways of output energy being same or different. Certainly, the device may combine multiple ways of signal energies into a one-way output reversely, and the device is called a combiner in this case.

In the second embodiment, the plurality of antenna units include: a first antenna unit 40, a second antenna unit 50, a third antenna unit 60, and a fourth antenna unit 70. The first antenna unit 40, the second antenna unit 50, the third antenna unit 60, and the fourth antenna unit 70 are arranged in a straight line.

Four antenna units 40, 50, 60, and 70 are electrically connected to the power splitter 80, respectively, and each antenna unit 40, 50, 60, and 70 includes a power attenuator 4 and a radiation portion 1.

With reference to FIG. 2, the radiation portion 1 is disposed on a first dielectric substrate 10 and the power attenuator 4 is disposed on a second dielectric substrate 30. A ground plate 20 is further disposed between the first dielectric substrate 10 and the second dielectric substrate 30. Four through-holes 2 are defined on the ground plate 20, and a number of the through-holes 2 is same as a number of the antenna units.

The power attenuator 4 is electrically connected to the power splitter 80, and the power attenuator 4 is configured to load an algorithm to attenuate power of an input signal. The algorithm is one of a Dolph-Chebyshev algorithm, a Taylor algorithm, and combinations thereof. In the second embodiment, the four antenna units are divided into a group of antenna arrays, and the power attenuator 4 in the antenna array is loaded with the Dolf-Chebyshev algorithm or the Taylor algorithm. Therefore, only one of the Dolf-Chebyshev algorithm or the Taylor algorithm is loaded in the antenna apparatus in the second embodiment.

It should be noted that current distribution in the Dolph-Chebyshev algorithm may transfer a part of energy of sidelobes to a main lobe, thereby reducing sidelobe levels, and obtaining a narrowest main lobe width, or obtaining a lowest sidelobe level at a given main lobe width. Unlike the Dolf-Chebyshev algorithm that maintains a same sidelobe level, Taylor distribution may allow several sidelobes near the main lobe to have the same levels, while remaining sidelobe levels tend to decrease sequentially. The Taylor distribution adjusts the sidelobe levels by positions of nulls of a lobe, and the sidelobe levels farther away from the main lobe are known to decrease sequentially. For the sidelobes close to the main lobe, the positions of the nulls of the lobe are shifted towards a direction of the main lobe so as to reduce corresponding sidelobe levels.

The four antenna units may be arranged in a straight line, but is not limited thereto, in other embodiments, the four antenna units may be arranged in a curve.

Amplitudes of signals input by the four antenna units are same, but amplitudes of the signals output by the four antenna units are not necessarily same. Specifically, the amplitudes of the signal output by the antenna units are determined according to positions of the four antenna units arranged in the antenna array. For example, when the antenna array is arranged in a straight line, output amplitudes of the antenna units in a middle are greater than the output amplitudes of the antenna units on two sides.

The radiation portion 1 is configured to transmit a received signal to the power attenuator 4 or receive a transmitted signal from the power attenuator 4.

The antenna apparatus further includes: a phase shifter 3.

The phase shifter 3 is electrically connected to the power attenuator 4, and the phase shifter 3 is configured to change phases of the main lobe of the signal.

When the antenna apparatus transmits a signal, the signal is transmitted from the corresponding circuit inside the terminal device to the power splitter 80, and the power splitter 80 divides the signal into four ways (a same number as four antenna units) of equal-amplitude signals. The four ways of equal-amplitude signals pass through the power attenuator 4, respectively, and the power attenuator 4 is loaded with the Dolph-Chebyshev algorithm or the Taylor algorithm to attenuate power of the equal-amplitude signals inputted accordingly. An attenuated signal passes through the phase shifter 3, which adjusts transmission phase thereof. Finally, it is emitted from the radiation portion 1 of the antenna unit. The radiation portion 1 and the phase shifter 3 are not directly connected, and the signal is coupled to the radiation portion 1 through the through-hole 2 on the ground plate 20.

When the antenna apparatus receives a signal from outside the terminal device, the signal is fed by a plurality of radiation portions 1 into the four antenna units. Four radiation portions 1 couple the received signal through the through-hole 2 to the phase shifter 3, by which a received phase of the signal is adjusted. A phase-adjusted signal is passed through the power attenuator 4, and the power attenuators 4 is loaded with the Dolf-Chebyshev algorithm or the Taylor algorithm to attenuate power of the received signal accordingly. After attenuated multi-way signals are sent to the power splitter 80, the power splitter 80 will combine the attenuated four signals into one signal at this time.

An advantage of the present application is that, in the present application, a power attenuator is added to each antenna unit of the array antenna, and the power attenuator is used to load the Dolph-Chebyshev algorithm and/or the Taylor algorithm so as to attenuate power of an input signal, which can effectively inhibit side lobe gain of the array antenna, and ensure identical main lobe gain and width.

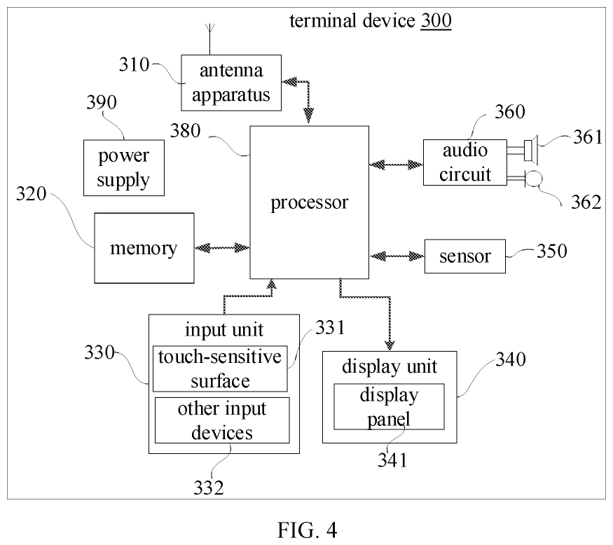

As shown in FIG. 4, which is a terminal device provided by an embodiment of the present application. The terminal device may be a smart phone, a tablet computer, and the like.

An antenna apparatus 310 may be configured to receive and transmit electromagnetic waves and to realize mutual conversions of the electromagnetic waves and electrical signals, thereby communicating with a communication network or any other devices. A memory 320 may be configured to store software programs and modules. A processor 380 performs a variety of functional applications and data processing by executing the software programs and the modules stored in the memory 320. The memory 320 may include a high speed random access memory, and may further include a nonvolatile memory, such as one or more of a magnetic disk storage device, a flash memory, or another non-volatile solid state storage devices. In some instances, the memory 320 may further include memory remotely located relative to the processor 380, and such remote memory can be connected to the terminal device 300 via a network. Examples of the network include, but are not limited to, an internet, an intranet, a local area network, a mobile communication network, and any combinations thereof.

An input unit 330 may be configured to receive numeric or character information inputted and to generate input signals of a keyboard, a mouse, a lever, an optics, or a trackball related to user settings and functional controls. Specifically, the input unit 330 may include a touch-sensitive surface 331 and other input devices 332. The touch-sensitive surface 331, also known as a touch display or a trackpad, collects touch operations of users on or near the surface, such as operations on the touch-sensitive surface 331 or near the touch-sensitive surface 331 triggered by the users using a finger, stylus, or any suitable object or accessory, and drives a corresponding device connected therewith according to a preset program. The touch-sensitive surface 331 can optionally include two parts: a touch detection device and a touch controller. Wherein, the touch detection device detects touch locations and directions of the users, detects signals generated by the touch operations, and transmits the signals to the touch controller. The touch controller receives touch signals from the touch detection device, converts the touch signals into contact coordinates, and sends the contact coordinates to the processor 380, and can receive and execute commands from the processor 380. Additionally, the touch-sensitive surface 331 can be implemented by various types of resistive, capacitive, infrared, and surface acoustic wave touch-sensitive surfaces. In addition to the touch-sensitive surface 331, the input unit 330 can also include the other input devices 332. Specifically, the other input devices 332 may include, but are not limited to, one or more of physical keyboards, function keys such as volume control keys, switching keys, etc., trackballs, mice, levers, and the like.

A display unit 340 may be configured to display information input by users or presented the information to the users as well as to various graphical user interfaces (GUIs) of the terminal device 300, which can include graphics, texts, icons, videos, and any combinations thereof. The display unit 340 may include a display panel 341, which may be optionally configured with forms of a liquid crystal display (LCD), an organic light-emitting diode (OLED), etc. Further, the touch-sensitive surface 331 can cover the display panel 341. When detecting the touch operations on surface or the touch operations in proximity, the touch-sensitive surface 331 transmits the detected operations to the processor 380 to determine a type of a touch event. The processor 380 provides a corresponding visual output on the display panel 341 according to the type of the touch event. Although the touch-sensitive surface 331 and the display panel 341 in FIG. 4 are used as two separate components to implement input and output functions, in some embodiments, the touch-sensitive surface 331 can be integrated with the display panel 341 to implement the input and output functions.

The terminal device 300 may also include at least one sensor 350, such as an optical sensor, a motion sensor, and a sensor of other types. Specifically, the optical sensor may include an ambient light sensor and a proximity sensor. Wherein, the ambient light sensor can adjust brightness of the display panel 341 according to brightness and darkness of ambient light. The proximity sensor can turn off the display panel 341 and/or backlight when the terminal device 300 moves near an ear. As a type of a motion sensor, a gravity acceleration sensor can detect magnitude of acceleration in all directions, generally three axes, and detect a level and a direction of gravity at rest. The gravity acceleration sensor can be used in applications of identifying mobile phone orientation, such as vertical and horizontal screen switching, games, and magnetometer calibration, applications of vibration recognition related functions, such as pedometers and tapping. The terminal device 300 can also be configured with gyroscopes, barometers, hygrometers, thermometers, infrared sensors, and other sensors, and details are not described here.

An audio circuit 360, a speaker 361, and a microphone 362 can provide an audio interface between a user and the terminal device 300. The audio circuit 360 can receive electrical signals converted from audio data and transmit received electrical signals to the speaker 361. The speaker 361 converts the electrical signals to sound signals for output. On another hand, the microphone 362 converts collected sound signals into electrical signals, which are received and converted by the audio circuit 360 into audio data. The audio data is output to the processor 380 for processing and is sent to, for example, another terminal device through the antenna apparatus 310. Alternatively, the audio data is output to the memory 320 for further processing. The audio circuit 360 may also include a headset jack for communicationally interfacing a peripheral headset and the terminal device 300.

The processor 380 is a control center of the terminal device 300 and is connected to various parts of the phone by using various interfaces and lines. By running or executing a software program and/or module stored in the memory 320 and invoking data stored in the memory 320, the processor 380 executes various functions of the terminal device and performs data processing, thereby performing an overall monitoring on a cell phone. The processor 380 may optionally include one or more processing cores. In some embodiments, the processor 380 may integrate an application processor and a modem processor. The application processor mainly processes an operating system, a user interface, an application program, and the like. The modem processor mainly processes wireless communication. It may be understood that the foregoing modem processor may alternatively not be integrated into the processor 380.

The terminal device 300 further includes a power supply 390, such as batteries, for supplying power to various components. In some embodiments, the power supply may be logically connected to the processor 380 by a power management system, thereby implementing management functions such as charging, discharging, and power consumption management by the power management system. The power supply 390 may further include one or more of direct current (DC) or alternate current (AC) power supplies, re-charging systems, power fault detection circuits, power converters or inverters, power state indicators, or any other components.

Although not shown in the figure, the terminal device 300 may further include a camera, such as a front camera and a rear camera, a BLUETOOTH module, etc., and details are not further described here.

In a specific implementation, the above modules may be implemented as independent entities, or may be arbitrarily combined, to implement as a same or several entities. For the specific implementation of the above modules, the above method embodiments may be referred to, which will not be further described here again.

When the terminal device 300 of this embodiment adopts the antenna apparatus 310 described in the foregoing embodiments, a display effect thereof is better.

In the foregoing embodiments, the description of each embodiment has its own emphasis. For the part that is not described in detail in an embodiment, reference may be made to the relevant description of other embodiments.

The antenna apparatus and the terminal device provided in the embodiments of the present application are described in detail above, and specific examples are used to illustrate principles and implementations of the present application. The descriptions of the above embodiments are merely used to help understand the methods and core ideas of the present application. A person of ordinary skill in the art should understand that he may still make modifications to the technical solutions described in the foregoing embodiments, or make equivalent replacements to some technical features thereof, without departing from the spirit and scope of the technical solutions of the embodiments of the present application.

1. An antenna apparatus, comprising:
a power splitter; and
a plurality of antenna units electrically connected to the power splitter, and each antenna unit comprises:
a power attenuator electrically connected to the power splitter, wherein the power attenuator is configured to load an algorithm to attenuate power of an input signal; and
a radiation portion configured to transmit a received signal to the power attenuator and/or to receive a transmitted signal from the power attenuator;
each antenna unit further includes: a phase shifter electrically connected to the power attenuator; and
the algorithm is one of a Dolph-Chebyshev algorithm, a Taylor algorithm, and combinations thereof.

2. The antenna apparatus as claimed in claim 1, wherein the radiation portion is disposed on a first dielectric substrate.

3. The antenna apparatus as claimed in claim 2, wherein the power attenuator is disposed on a second dielectric substrate.

4. An antenna apparatus, comprising:
a power splitter; and
a plurality of antenna units electrically connected to the power splitter, and each antenna unit includes:
a power attenuator electrically connected with the power splitter, wherein the power attenuator is configured to load an algorithm to attenuate power of an input signal; and
a radiation portion configured to transmit a received signal to the power attenuator and/or to receive a transmitted signal from the power attenuator.

5. The antenna apparatus as claimed in claim 4, wherein each antenna unit further includes: a phase shifter electrically connected to the power attenuator.

6. The antenna apparatus as claimed in claim 5, wherein the radiation portion is disposed on a first dielectric substrate.

7. The antenna apparatus as claimed in claim 6, wherein the power attenuator is disposed on a second dielectric substrate.

8. The antenna apparatus as claimed in claim 7, wherein the phase shifter is disposed on the second dielectric substrate.

9. The antenna apparatus as claimed in claim 7, wherein a ground plate is further disposed between the first dielectric substrate and the second dielectric substrate, and a plurality of through-holes are defined on the ground plate, and a number of the through-holes is same as a number of the antenna units.

10. The antenna apparatus as claimed in claim 4, wherein the plurality of antenna units include: a first antenna unit, a second antenna unit, a third antenna unit, and a fourth antenna unit; and the first antenna unit, the second antenna unit, the third antenna unit, and the fourth antenna unit are arranged in a straight line.

11. The antenna apparatus as claimed in claim 4, wherein the algorithm is one of a Dolph-Chebyshev algorithm, a Taylor algorithm, and combinations thereof.

12. The antenna apparatus as claimed in claim 4, wherein amplitudes of signals input by each antenna unit are same.

13. A terminal device, comprising the antenna device as claimed in claim 4.

14. The terminal device as claimed in claim 13, wherein each antenna unit further includes: a phase shifter electrically connected to the power attenuator.

15. The terminal device as claimed in claim 13, wherein the radiation portion is disposed on a first dielectric substrate; the power attenuator is disposed on a second dielectric substrate; each antenna unit further includes: a phase shifter electrically connected to the power attenuator; and the phase shifter is disposed on the second dielectric substrate.

16. The terminal device as claimed in claim 15, wherein a ground plate is further disposed between the first dielectric substrate and the second dielectric substrate, and a plurality of through-holes are defined on the ground plate, and a number of the through-holes is same as a number of the antenna units.

17. The terminal device as claimed in claim 13, wherein the plurality of antenna units include: a first antenna unit, a second antenna unit, a third antenna unit, and a fourth antenna unit; and the first antenna unit, the second antenna unit, the third antenna unit, and the fourth antenna unit are arranged in a straight line.

18. The terminal device as claimed in claim 13, wherein the algorithm is one of a Dolph-Chebyshev algorithm, a Taylor algorithm, and combinations thereof.
